(19) United States
(12) Patent Application Publication
(10) Pub. No.: US 2007/0020443 A1
(43) Pub. Date: Jan. 25, 2007

(54) Card with a picture-contained mirror surface layer

(76) Inventor: Tsung-Lai Lo, Taipei Hsien (TW)

Correspondence Address: Tsung-Lai Lo, 235 Chung-Ho, Box 8-24, Taipei, TW

(21) Appl. No.: 11/184,580

(22) Filed: Jul. 20, 2005

(51) Int. Cl. B32B 3/00

(52) U.S. Cl. 428/195.1

(57) ABSTRACT

A card with a picture-contained mirror surface layer comprises an upper covering layer; an upper middle layer installed below the upper covering layer; a lower middle layer installed below the upper middle layer; a lower covering layer installed below the lower middle layer; and a picture-contained mirror surface layer installed at a position between the upper covering layer and the upper middle layer or between the upper middle layer and the lower middle layer, or the picture-contained mirror surface layer is installed between the lower middle layer and the lower covering layer. Or the combination of the different layers is performed by mechanically melting the layers and then combining the melting layers. The picture-contained mirror surface layer is made from compound material or metals. The picture is selected from textures, numbers, figures, or the combinations of above items. The different layers have present different light effect.

### FIELD OF THE INVENTION

The present invention relates to a card with a picture-contained mirror surface layer, wherein the present invention presents figures with various light effects on the cards, which may be presented as a three dimensional drawings. Furthermore, the present invention may have mirror effects. However these effects cannot be achieved by the prior arts. In the prior art, the picture on the card is two-dimensional and has no light effect.

### BACKGROUND OF THE INVENTION

Currently, cards are used in many fields, such as financial cards, cash cards, credit cards, chip cards, telephone cards, entrance control cards, ticket cards, etc. However the conventional cards are dull. The pictures on the conventional cards are not vivid, has no three dimensional effect and can not present various light effect. The pictures are directly printed upon the cards. Thereby it can be matched to the current trends for novelty designs.

### SUMMARY OF THE INVENTION

Accordingly, the primary object of the present invention is to provide a card with a picture-contained mirror surface layer, wherein The present invention present figures with various light effects on the cards, which may be presented as a three dimensional drawings. Furthermore, the present invention may have mirror effects. However these effects can not be achieved by the prior arts. In the prior art, the picture on the card is two-dimensional and has no light effect.

To achieve above objects, the present invention provides a card with a picture-contained mirror surface layer which comprises an upper covering layer; an upper middle layer installed below the upper covering layer; a lower middle layer installed below the upper middle layer; a lower covering layer installed below the lower middle layer; and a picture-contained mirror surface layer installed at a position between the upper covering layer and the upper middle layer or between the upper middle layer and the lower middle layer, or the picture-contained mirror surface layer is installed between the lower middle layer and the lower covering layer. Or the combination of the different layers is performed by mechanically melting the layers and then combining the melting layers. The picture-contained mirror surface layer is made from compound material or metals. The picture on The picture-contained mirror surface layer is selected from textures, numbers, figures, or the combinations of above items. The different layers have present different light effect.

The various objects and advantages of the present invention will be more readily understood from the following detailed description when read in conjunction with the appended drawing.

### BRIEF DESCRIPTION OF THE DRAWINGS

FIG. 1 is an exploded perspective view of the card with a picture-contained mirror surface layer of the present invention.

FIG. 2 shows the combination of various layers according to the present invention.

FIG. 3 shows one arrangement of the present invention.

FIG. 4 shows another arrangement of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

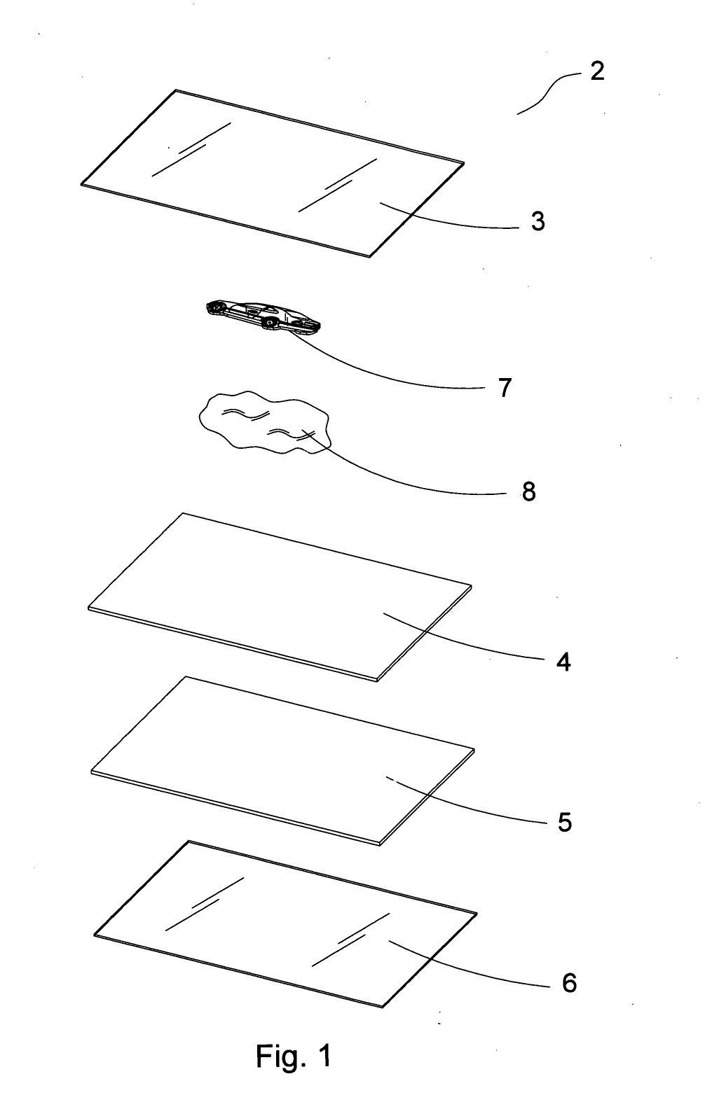

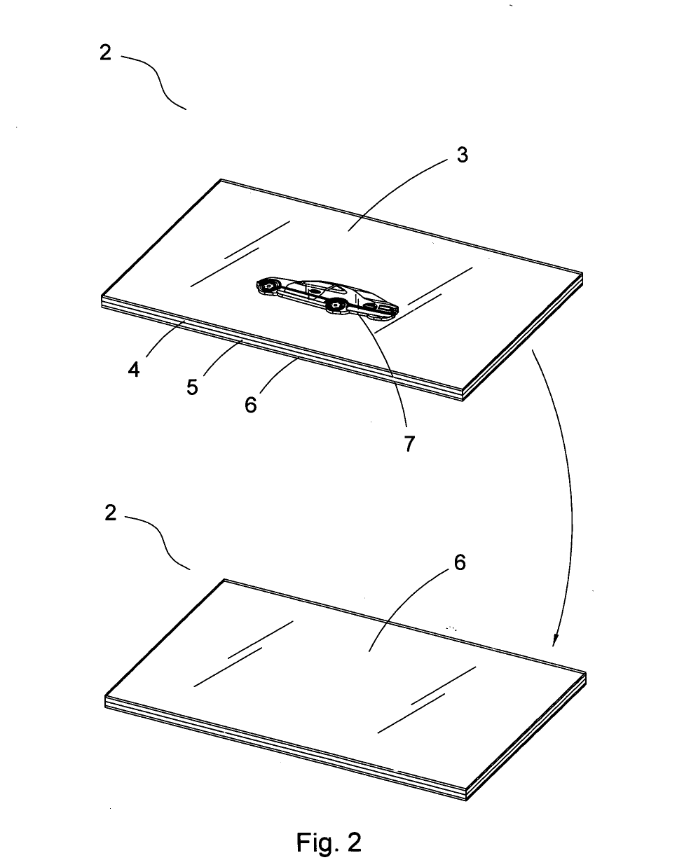

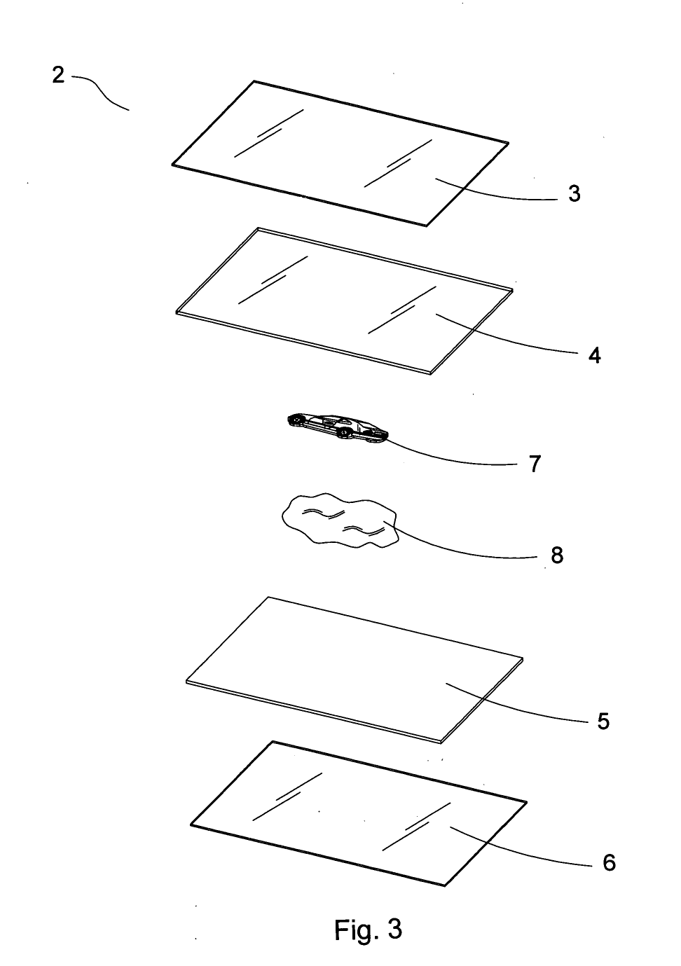

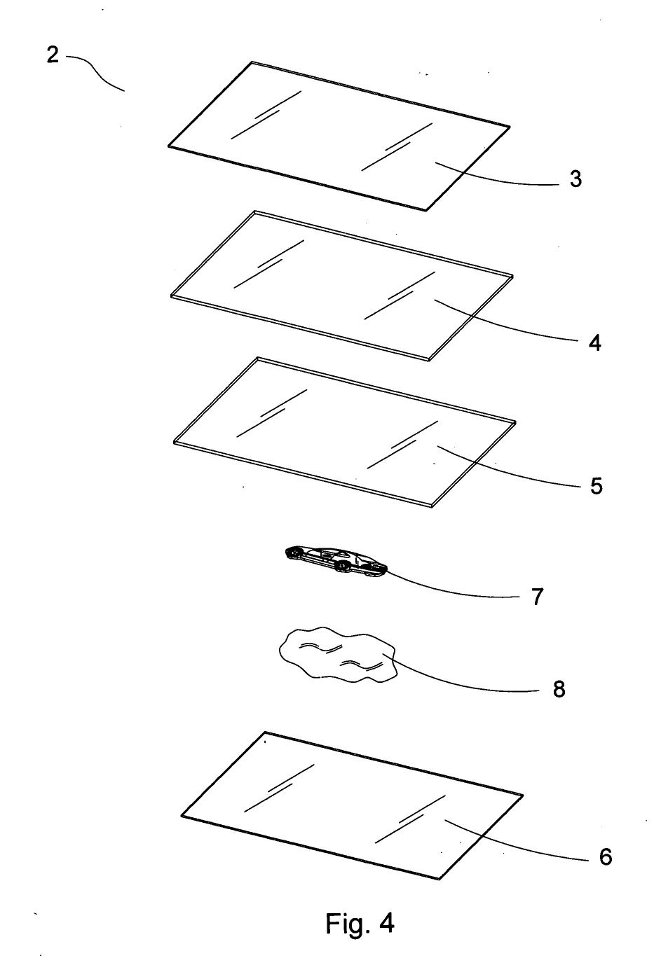

Referring to FIGS. 1 to 4, a card 2 with picture-contained mirror surface layer of the present invention is illustrated. The present invention has the following elements.

An upper covering layer 3 is located at an upper side of the card.

An upper middle layer 4 is installed below the upper covering layer 3.

A lower middle layer 5 is installed below the upper middle layer 4.

A lower covering layer 6 is installed below the lower middle layer 5.

A picture-contained mirror surface layer 7 is selectively installed between the upper covering layer 3 and the upper middle layer 4 or between the upper middle layer 4 and the lower middle layer 5 or between the lower middle layer 5 and the lower covering layer 6. The installation of the picture-contained mirror surface layer 7 connected another layers are performed by glue agent 8 or through melting by machines. The glue agent 8 is selected from ultraviolet harden adhesive, thermal melting adhesive, pressure-sensitive adhesive. The picture-contained mirror surface layer 7 is made from compound material or metals.

The above mentioned layers are combined by compression from an upper and a lower sides. The upper covering layer 3, upper middle layer 4, lower middle layer 5, and lower covering layer 6 may be transparent or semi-transparent, or the layers above The picture-contained mirror surface layer 7 are transparent or semi-transparent, but the layers below the picture-contained mirror surface layer 7 are not transparent. However all above mentioned constructions can present a picture on the picture-contained mirror surface layer 7 with various effect.

The picture on The picture-contained mirror surface layer 7 is selected from textures, numbers, figures, or the combinations of above items or others. All these are within the scope of the present invention. Moreover, the different layers may present different light effect so that the pictures on The picture-contained mirror surface layer 7 has a three dimensional effect.

Furthermore, the present invention is suitable to be used in credit cards, chip cards, telephone cards, cash cards, door cards, ticket cards, financial cards, etc.

Advantages of the present invention will be described herein. The present invention present figures with various light effects on the cards, which may be presented as a three dimensional drawings. Furthermore, the present invention may have mirror effects. However these effects can not be achieved by the prior arts. In the prior art, the picture on the card is two dimensional and has no light effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A card with a picture-contained mirror surface layer comprising:
an upper covering layer;
an upper middle layer installed below the upper covering layer;
a lower middle layer installed below the upper middle layer;
a lower covering layer installed below the lower middle layer; and
a picture-contained mirror surface layer having pictures thereon and having a mirror surface.

2. The card with a picture-contained mirror surface layer as claimed in claim 1, wherein The picture-contained mirror surface layer is installed between the upper covering layer and the upper middle layer.

3. The card with a picture-contained mirror surface layer as claimed in claim 1, wherein The picture-contained mirror surface layer is installed between the upper middle layer and the lower middle layer.

4. The card with a picture-contained mirror surface layer as claimed in claim 1,wherein The picture-contained mirror surface layer is installed between the lower middle layer and the lower covering layer.

5. The card with a picture-contained mirror surface layer as claimed in claim 1, wherein the combination of the different layers are performed by mechanically melting the layers and then combining the melting layers.

6. The card with a picture-contained mirror surface layer as claimed in claim 1, wherein The picture-contained mirror surface layer is made from compound material or metals.

7. The card with a picture-contained mirror surface layer as claimed in claim 1, wherein the picture on The picture-contained mirror surface layer is selected from textures, numbers, figures, or the combinations of above items.

8. The card with a picture-contained mirror surface layer as claimed in claim 1, wherein the different layers have present different light effect.

9. The card with a picture-contained mirror surface layer as claimed in claim 1, wherein the upper covering layer, upper middle layer, lower middle layer, and lower covering layer are transparent or semi-transparent.

10. The card with a picture-contained mirror surface layer as claimed in claim 1, wherein the layers above The picture-contained mirror surface layer are transparent or semi-transparent, but the layers below the picture-contained mirror surface layer are not transparent.
